(19) United States
(12) Patent Application Publication
(10) Pub. No.: US 2025/0367551 A1
(43) Pub. Date: Dec. 4, 2025

(54) VEHICLE INFOTAINMENT SYSTEM AND CONTROL METHOD FOR OPERATING IN GAME MODE

(71) Applicants: Hyundai Motor Company, Seoul (KR); Kia Corporation, Seoul (KR)

(72) Inventors: Hanghang Wang, Shandong (CN); Jin Shun Li, Shandong (CN); Guang Li Xue, Shandong (CN); Hui Xie, Shandong (CN)

(21) Appl. No.: 19/096,169

(22) Filed: Mar. 31, 2025

(30) Foreign Application Priority Data
May 31, 2024 (CN) 202410702590.6

(51) Int. Cl. A63F 13/42; A63F 13/533; A63F 13/79; A63F 13/803

(52) U.S. Cl. CPC A63F 13/42; A63F 13/533; A63F 13/79; A63F 13/803

(57) ABSTRACT

A vehicle infotainment system includes a memory and a controller. The memory stores a correspondence relationship between a button operation signal and a vehicle game command. The controller receives the button operation signal transmitted from a vehicle key, where different buttons may transmit different button operation signals, determine whether a vehicle is in a game mode, determine whether a state of the vehicle and a state of the vehicle key each satisfy a preset condition in response to determining that the vehicle is in the game mode, and determine, in response to determining that the state of the vehicle and the state of the vehicle key each satisfy the preset condition, the vehicle game command corresponding to the received button operation signal to operate a vehicle game based on the correspondence relationship between the button operation signal and the vehicle game command stored in the memory.

### CROSS-REFERENCE TO RELATED APPLICATION

This application claims under 35 U.S.C. § 119(a) the benefit of Chinese Patent Application No. 202410702590.6 filed with the Chinese Intellectual Property Office on May 31, 2024, the entire contents of which are incorporated herein by reference.

### BACKGROUND

### (a) Technical Field

The present disclosure relates to a vehicle infotainment system and a control method, more particularly, to the vehicle infotainment system and control method configured to operate in a game mode.

### (b) Description of the Related Art

As vehicles become more electrified and intelligent, vehicle infotainment systems are changing from single content output types to interactive types. In particular, interactive game functions are being added to more and more vehicle infotainment systems. In a method of playing a game in a vehicle according to a related art, a purchased game controller is connected to a vehicle central control system, and a key code value on the game controller is mapped to a game operation interface to implement game operation. Therefore, a user needs to purchase the game controller, which may increase expenses of the user. In addition, even in a case where the user does not frequently use the game function, the game controller needs to be kept in the vehicle for a long time. Furthermore, the game controller and the vehicle central control system are paired via Bluetooth or connected via wires, and such a complicated connection method is difficult for elderly persons and children to handle, and thus, it may be inconvenient to use the game controller.

Therefore, there is a need for a method that allows the user to operate a vehicle game without increasing expenses of the user. In addition, there is a need for a way in which a device for operating a vehicle game by a user and a vehicle central control system may be automatically connected without separate operation by the user.

The above information disclosed in this Description of the Related Art section is only for enhancement of understanding of the background of the disclosure and therefore it may contain information that does not form the prior art that is already known to a person of ordinary skill in the art.

### SUMMARY

The present disclosure provides a vehicle infotainment system and a control method thereof that utilize a vehicle key as a vehicle game operation device without requiring a user to spend money on purchasing a game controller. Since the vehicle key and a vehicle are connected without separate operation by the user, convenience of a usage process may be increased.

According to the present disclosure, a vehicle infotainment system includes: a memory configured to store a correspondence relationship between a button operation signal and a vehicle game command; and a controller configured to: receive the button operation signal transmitted from a vehicle key; determine whether a vehicle is in a game mode; determine whether a state of the vehicle and a state of the vehicle key each satisfy a preset condition in response to determining that the vehicle is in the game mode; and determine, in response to determining that the state of the vehicle and the state of the vehicle key each satisfy the preset condition, the vehicle game command corresponding to the received button operation signal to operate a vehicle game based on the correspondence relationship between the button operation signal and the vehicle game command stored in the memory.

According to another aspect of the present disclosure, a vehicle infotainment system including a memory and a controller is provided. The memory is configured to store a correspondence relationship between a button operation signal and a vehicle game command. The controller is configured to: receive the button operation signal transmitted from a vehicle key wherein different buttons may transmit different button operation signals; determine whether a vehicle is in a game mode; determine whether a state of the vehicle and a state of the vehicle key each satisfy a preset condition in response to determining that the vehicle is in the game mode; and determine, in response to determining that the state of the vehicle and the state of the vehicle key each satisfy the preset condition, the vehicle game command corresponding to the received button operation signal to operate a vehicle game based on the correspondence relationship between the button operation signal and the vehicle game command stored in the memory.

The controller may be configured to operate the vehicle according to the button operation signal in response to determining that the vehicle is not in the game mode.

The controller may be configured to output a corresponding notification signal in response to determining that the state of the vehicle and/or the state of the vehicle key does not satisfy the preset condition.

The controller may be further configured to: determine whether the state of the vehicle satisfies the preset condition in response to determining that the vehicle is in the game mode; determine whether the state of the vehicle key satisfies the preset condition in response to determining that the state of the vehicle satisfies the preset condition; and output the corresponding notification signal in response to determining that the state of the vehicle does not satisfy the preset condition, or determining that the state of the vehicle satisfies the preset condition and the state of the vehicle key does not satisfy the preset condition.

The controller may be configured to: determine whether an ignition switch of the vehicle is in an ignition on (IGN ON) state, whether a vehicle gear position is in a P position, whether the vehicle is in a braking state, whether a battery power level of the vehicle is higher than a first battery power level threshold, and whether a vehicle speed is 0, when determining whether the state of the vehicle satisfies the preset condition; and determine that the state of the vehicle satisfies the preset condition when the ignition switch of the vehicle is in the IGN ON state, the vehicle gear position is in the P position, the vehicle is in the braking state, the battery power level of the vehicle is higher than the first battery power level threshold, and the vehicle speed is 0.

The controller may be further configured to: output the notification signal regarding the ignition switch or a power of the vehicle in response to determining that the ignition switch of the vehicle is not in the IGN ON state; determine whether the vehicle gear position is in the P position in response to determining that the ignition switch of the vehicle is in the IGN ON state; output the notification signal regarding the vehicle gear position in response to determining that the vehicle gear position is not in the P position; determine whether the vehicle is in the braking state in response to determining that the vehicle gear position is in the P position; output the notification signal regarding the braking state of the vehicle in response to determining that the vehicle is not in the braking state; determine whether the battery power level of the vehicle is higher than the first battery power level threshold in response to determining that the vehicle is in the braking state; output the notification signal regarding the battery power level of the vehicle in response to determining that the battery power level of the vehicle is equal to or lower than the first battery power level threshold; determine whether the vehicle speed is 0 in response to determining that the battery power level of the vehicle is higher than the first battery power level threshold; and output the notification signal regarding the vehicle speed in response to determining that the vehicle speed is not 0.

The controller may be configured to: determine whether identity authentication information of the vehicle key matches and determine whether a battery power level of the vehicle key is higher than a second battery power level threshold, when determining whether the state of the vehicle key satisfies the preset condition; and determine that the state of the vehicle key satisfies the preset condition when the identity authentication information of the vehicle key matches and the battery power level of the vehicle key is higher than the second battery power level threshold.

The controller may be further configured to: output the notification signal regarding the vehicle key in response to determining that the identity authentication information of the vehicle key does not match; determine whether the battery power level of the vehicle key is higher than the second battery power level threshold in response to determining that the identity authentication information of the vehicle key matches; and output the notification signal regarding the battery power level of the vehicle key in response to determining that the battery power level of the vehicle key is equal to or lower than the second battery power level threshold.

The vehicle key may be a remote control key, the button operation signal may include a door lock signal, a door unlock signal, a vehicle search signal, a remote start signal, a rear trunk operation signal, and a front trunk operation signal, the vehicle game command corresponding to the door lock signal may be moving to the left, the vehicle game command corresponding to the door unlock signal may be moving downward, the vehicle game command corresponding to the vehicle search signal may be moving to the right, the vehicle game command corresponding to the remote start signal may be moving upward, the vehicle game command corresponding to the rear trunk operation signal may be confirmation, and the vehicle game command corresponding to the front trunk operation signal may be cancellation.

The vehicle key may be a terminal device on which a vehicle key application is installed, the button operation signal may include an engine start signal, an engine stop signal, a door lock signal, a door unlock signal, a vehicle search signal, and a vehicle light operation signal, the vehicle game command corresponding to the engine start signal may be moving to the left, the vehicle game command corresponding to the engine stop signal may be moving to the right, the vehicle game command corresponding to the door lock signal may be moving upward, the vehicle game command corresponding to the door unlock signal may be moving downward, the vehicle game command corresponding to the vehicle search signal may be confirmation, and the vehicle game command corresponding to the vehicle light operation signal may be cancellation. A vehicle may include the vehicle infotainment system.

According to another embodiment of the present disclosure, a control method of a vehicle infotainment system includes: determining, by a controller, whether a vehicle is in a game mode; determining, by the controller, whether a state of the vehicle and a state of the vehicle key each satisfy a preset condition in response to determining that the vehicle is in the game mode; and determining, by the controller, in response to determining that the state of the vehicle and the state of the vehicle key each satisfy the preset condition, a vehicle game command corresponding to a received button operation signal to operate a vehicle game based on a prestored correspondence relationship between the button operation signal and the vehicle game command.

According to a further aspect, a control method of a vehicle infotainment system is provided. The control method includes: receiving a button operation signal transmitted from a vehicle key wherein different buttons transmit different button operation signals; determining whether a vehicle is in a game mode; determining whether a state of the vehicle and a state of the vehicle key each satisfy a preset condition in response to determining that the vehicle is in the game mode; and determining, in response to determining that the state of the vehicle and the state of the vehicle key each satisfy the preset condition, a vehicle game command corresponding to the received button operation signal to operate a vehicle game based on a prestored correspondence relationship between the button operation signal and the vehicle game command.

The control method may further include operating the vehicle according to the button operation signal in response to determining that the vehicle is not in the game mode.

The control method may further include outputting a corresponding notification signal in response to determining that the state of the vehicle or the state of the vehicle key does not satisfy the preset condition.

The determining whether a state of the vehicle and a state of the vehicle key each satisfy a preset condition may include: determining whether the state of the vehicle satisfies the preset condition; determining whether the state of the vehicle key satisfies the preset condition in response to determining that the state of the vehicle satisfies the preset condition; and outputting the corresponding notification signal in response to determining that the state of the vehicle does not satisfy the preset condition, or determining that the state of the vehicle satisfies the preset condition and the state of the vehicle key does not satisfy the preset condition.

The determining whether the state of the vehicle satisfies the preset condition may include: determining whether an ignition switch of the vehicle is in an IGN ON state; determining whether a vehicle gear position is in a P position; determining whether the vehicle is in a braking state; determining whether a battery power level of the vehicle is higher than a first battery power level threshold; determining whether a vehicle speed is 0; and determining that the state of the vehicle satisfies the preset condition when the ignition switch of the vehicle is in the IGN ON state, the vehicle gear position is in the P position, the vehicle is in the braking state, the battery power level of the vehicle is higher than the first battery power level threshold, and the vehicle speed is 0.

The determining whether the state of the vehicle satisfies the preset condition may include: outputting the notification signal regarding the ignition switch or a power of the vehicle in response to determining that the ignition switch of the vehicle is not in the IGN ON state; outputting the notification signal regarding the vehicle gear position in response to determining that the ignition switch of the vehicle is in the IGN ON state, and the vehicle gear position is not in the P position; outputting the notification signal regarding the braking state of the vehicle in response to determining that the vehicle gear position is in the P position, and the vehicle is not in the braking state; outputting the notification signal regarding the battery power level of the vehicle in response to determining that the vehicle is in the braking state, and the battery power level of the vehicle is equal to or lower than the first battery power level threshold; outputting the notification signal regarding the vehicle speed in response to determining that the battery power level of the vehicle is higher than the first battery power level threshold, and the vehicle speed is not 0; and determining that the state of the vehicle satisfies the preset condition in response to determining that the vehicle speed is 0.

The determining whether the state of the vehicle key satisfies the preset condition may include: determining whether identity authentication information of the vehicle key matches; determining whether a battery power level of the vehicle key is higher than a second battery power level threshold; and determining that the state of the vehicle key satisfies the preset condition when the identity authentication information of the vehicle key matches and the battery power level of the vehicle key is higher than the second battery power level threshold.

The determining whether the state of the vehicle key satisfies the preset condition may include: outputting the notification signal regarding the vehicle key in response to determining that the identity authentication information of the vehicle key does not match; outputting the notification signal regarding the battery power level of the vehicle key in response to determining that the identity authentication information of the vehicle key matches and the battery power level of the vehicle key is equal to or lower than the second battery power level threshold; and determining that the state of the vehicle key satisfies the preset condition in response to determining that the battery power level of the vehicle key is higher than the second battery power level threshold.

The vehicle key may be a remote control key, the button operation signal may include a door lock signal, a door unlock signal, a vehicle search signal, a remote start signal, a rear trunk operation signal, and a front trunk operation signal, the vehicle game command corresponding to the door lock signal may be moving to the left, the vehicle game command corresponding to the door unlock signal may be moving downward, the vehicle game command corresponding to the vehicle search signal may be moving to the right, the vehicle game command corresponding to the remote start signal may be moving upward, the vehicle game command corresponding to the rear trunk operation signal may be confirmation, and the vehicle game command corresponding to the front trunk operation signal may be cancellation.

The vehicle key may be a terminal device on which a vehicle key application is installed, the button operation signal may include an engine start signal, an engine stop signal, a door lock signal, a door unlock signal, a vehicle search signal, and a vehicle light operation signal, the vehicle game command corresponding to the engine start signal may be moving to the left, the vehicle game command corresponding to the engine stop signal may be moving to the right, the vehicle game command corresponding to the door lock signal may be moving upward, the vehicle game command corresponding to the door unlock signal may be moving downward, the vehicle game command corresponding to the vehicle search signal may be confirmation, and the vehicle game command corresponding to the vehicle light operation signal may be cancellation.

The present disclosure may adopt the above-described technical solution and obtain the following beneficial effects.

Since the user may operate the vehicle game by using the vehicle key, there is no need to purchase a separate game controller. In addition, when the user wants to operate the vehicle game, there is no need for the user to perform separate operation to connect the vehicle key to the vehicle, and thus, convenience of usage process may be increased.

Other effects that may be obtained or predicted from an embodiment of the present disclosure will be explicitly or implicitly described in the detailed description of the embodiments. That is, various effects that are predicted from embodiments of the present disclosure will be described in the following detailed description.

### BRIEF DESCRIPTION OF THE DRAWINGS

Hereinafter, exemplary embodiments of the present disclosure will be described in more detail by referring to the accompanying drawings. For clarity of explanation, the same components are indicated by the same reference numerals across different drawings. It should be noted that the drawings are exemplary only and are not necessarily drawn to scale.

FIG. 1 is a block diagram of a vehicle infotainment system according to an embodiment of the present disclosure;

FIG. 2 is a flowchart of an operation of a controller according to an embodiment of the present disclosure;

FIG. 3 is a flowchart of operation of the controller for determining whether a state of a vehicle satisfies a preset condition according to an embodiment of the present disclosure;

FIG. 4 is a flowchart of operation of the controller for determining whether a state of a vehicle key satisfies a preset condition according to an embodiment of the present disclosure;

FIGS. 5A and 5B illustrate schematic views of a free on board (FOB) key.

FIG. 6 illustrates a schematic diagram of game commands implemented in different operation situations by a door lock button;

FIGS. 7A and 7B are schematic views illustrating a user interface of a vehicle key application of a smartphone; and

FIG. 8 is a block diagram of a detailed configuration of a vehicle infotainment system according to an embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail, and the present embodiment is implemented based on the technical solutions of the present disclosure, and detailed embodiments and specific operation processes are disclosed, but the protection scope of the present disclosure is not limited to the following embodiments.

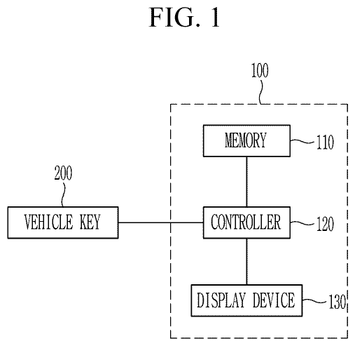

FIG. 1 is a block diagram of a vehicle infotainment system according to an embodiment of the present disclosure. As illustrated in FIG. 1, a vehicle infotainment system 100 may include a memory 110, a controller 120, and a display device 130. The memory 110 may be configured to store a correspondence relationship between a button operation signal and a vehicle game command. The controller 120 may receive the button operation signal transmitted from a vehicle key 200 (different buttons on the vehicle key 200 may transmit different button operation signals) and determine whether a vehicle is in a game mode. If it is determined that the vehicle is in the game mode, the controller 120 may be configured to determine whether a state of the vehicle and a state of the vehicle key each satisfy a preset condition. If it is determined that the state of the vehicle and the state of the vehicle key each satisfy the preset condition, the controller 120 may be configured to determine the vehicle game command to operate a vehicle game based on the correspondence relationship between the button operation signal and the vehicle game command stored in the memory 110 according to the received button operation signal.

According to an embodiment of the present disclosure, a user may operate the vehicle game by using the vehicle key 200, and thus, there is no need to purchase a separate game controller. In addition, the vehicle key 200 may be automatically connected to the vehicle. In one example, the vehicle key may be a free on board (FOB) key. If the FOB key is within a preset range inside or outside the vehicle, the FOB key may be connected to the vehicle, and the user may control a vehicle function by using a button on the FOB key. In another example, the vehicle key may be a terminal device (for example, a smartphone) on which a vehicle key application is installed. When using the vehicle key application for the first time, the user may need to bind the vehicle key application to the corresponding vehicle. Thereafter, the smartphone may be connected to the vehicle when the user simply opens the vehicle key application, and the user may check the state of the vehicle, control the vehicle function, receive an alarm and a notification, and the like in the vehicle key application. Accordingly, when the user wants to operate the vehicle game, the vehicle key and the vehicle are connected without separate operation by the user, so that convenience of a usage process may be increased.

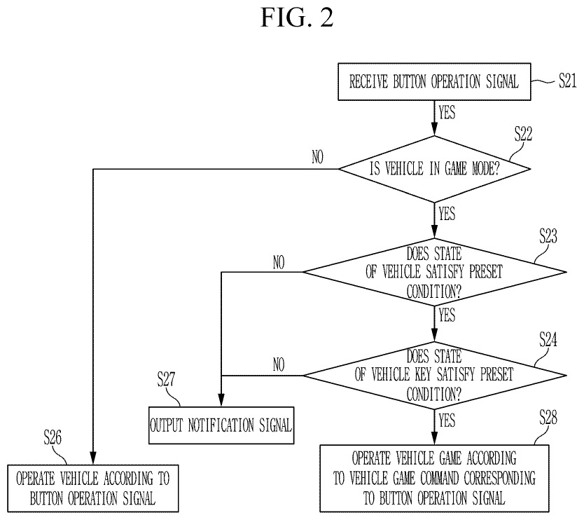

FIG. 2 is a flowchart of an operation of the controller according to an embodiment of the present disclosure. As illustrated in FIG. 2, when the controller 120 receives the button operation signal transmitted by the vehicle key 200 in step S21, the controller 120 may determine whether the vehicle is in the game mode in step S22. If it is determined that the vehicle is not in the game mode (“No” in the step S22), the controller 120 may operate the vehicle according to the button operation signal in step S26.

If the controller 120 determines that the vehicle is in the game mode (“Yes” in the step S22), the controller 120 may determine whether the state of the vehicle satisfies the preset condition in step S23. If the controller 120 determines that the state of the vehicle does not satisfy the preset condition (“No” in the step S23), the controller 120 may output a corresponding notification signal in step S27.

If the controller 120 determines that the state of the vehicle satisfies the preset condition (“Yes” in the step S23), the controller 120 may determine whether the state of the vehicle key satisfies the preset condition in step S24.

If the controller 120 determines that the state of the vehicle key satisfies the preset condition (“Yes” in the step S24), the controller 120 may receive the correspondence relationship between the button operation signal and the vehicle game command from the memory 110, determine the vehicle game command corresponding to the button operation signal received from the vehicle key 200, and operate the vehicle game in step S28.

If the controller 120 determines that the state of the vehicle key does not satisfy the preset condition (“No” in the step S24), the controller 120 may output the corresponding notification signal in step S27.

In addition, the display device 130 may receive the notification signal from the controller 120 and display notification information corresponding to the notification signal.

In one optional embodiment, after the controller 120 outputs the notification signal indicating that a user operation for the vehicle game is not successful, the controller 120 may operate the vehicle according to the button operation signal as before in the step S26. In another optional embodiment, the controller 120 may control the vehicle to automatically exit the game mode.

Although FIG. 2 illustrates that determining whether the state of the vehicle satisfies the preset condition and determining whether the state of the vehicle key satisfies the preset condition are sequentially performed, the present disclosure is not limited thereto. The determining whether the state of the vehicle satisfies the preset condition and the determining whether the state of the vehicle key satisfies the preset condition may be performed simultaneously or in a different order.

When the controller 120 determines whether the state of the vehicle satisfies the preset condition, the controller 120 may determine whether an ignition switch of the vehicle is in an ignition on (IGN ON) state, whether a vehicle gear position is in a P position, whether the vehicle is in a braking state, whether a battery power level of the vehicle is higher than a first battery power level threshold, and/or whether a vehicle speed is 0.

If the ignition switch of the vehicle is in the IGN ON state, the vehicle gear position is in the P position, the vehicle is in the braking state, the battery power level of the vehicle is higher than the first battery power level threshold, and the vehicle speed is 0, the controller 120 may determine that the state of the vehicle satisfies the preset condition.

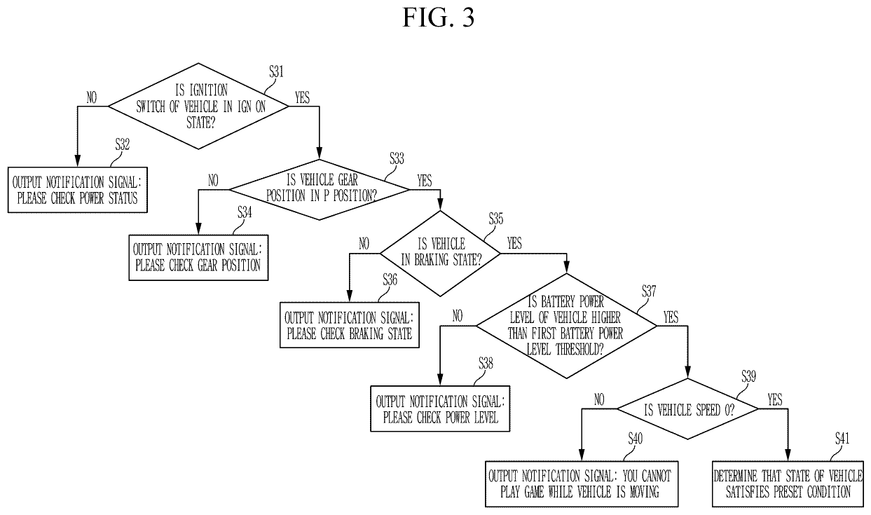

FIG. 3 is a flowchart of operation of the controller for determining whether the state of the vehicle satisfies the preset condition according to an embodiment of the present disclosure. As illustrated in FIG. 3, the controller 120 may determine whether the ignition switch of the vehicle is in the IGN ON state in step S31. The IGN ON state may mean a state in which power of the battery is supplied to an electric load in the vehicle.

If the controller 120 determines that the ignition switch of the vehicle is not in the IGN ON state (“No” in the step S31), this means that the power of the battery is not supplied to the electric load in the vehicle and the vehicle game may not be executed. Therefore, the controller 120 may output the notification signal regarding the ignition switch or the power of the vehicle. For example, the controller 120 may output the notification signal stating “Please check the power status” in step S32.

If the controller 120 determines that the ignition switch of the vehicle is in the IGN ON state (“Yes” in the step S31), the controller 120 may determine whether the vehicle gear position is in the P position in step S33. If the controller 120 determines that the vehicle gear position is not in the P position (“No” in the step S33), the controller 120 may output the notification signal regarding the vehicle gear position. For example, the controller 120 may output the notification signal stating “Please check the gear position” in step S34.

If the controller 120 determines that the vehicle gear position is in the P position (“Yes” in the step S33), the controller 120 may determine whether the vehicle is in the braking state in step S35. If the controller 120 determines that the vehicle is not in the braking state (“No” in the step S35), the controller 120 may output the notification signal regarding the braking state of the vehicle. For example, the controller 120 may output the notification signal stating “Please check the braking state” in step S36.

According to an embodiment of the present disclosure, the operation of the vehicle game may be performed only when the vehicle is in a safe state, and it is possible to determine whether the vehicle is in the safe state by determining whether the vehicle gear position is in the P position and whether the vehicle is in the braking state. In addition, an order in which determining whether the vehicle gear position is in the P position and determining whether the vehicle is in the braking state are performed may be adjusted.

If the controller 120 determines that the vehicle is in the braking state (“Yes” in the step S35), the controller 120 may determine whether the battery power level of the vehicle is higher than the first battery power level threshold in step S37. Since the operation of the vehicle game may consume the battery power of the vehicle, it is necessary to monitor a current battery power level of the vehicle to prevent basic functions of the vehicle from becoming unusable due to battery power consumption.

If the controller 120 determines that the battery power level of the vehicle is equal to or lower than the first battery power level threshold (“No” in the step S37), the controller 120 may output the notification signal regarding the battery power level of the vehicle. For example, the controller 120 may output the notification signal stating “Please check the power level” in step S38.

If the controller 120 determines that the battery power level of the vehicle is higher than the first battery power level threshold (“Yes” in the step S37), the controller 120 may determine whether the vehicle speed is 0 in step S39. According to an embodiment of the present disclosure, if it is determined that the vehicle is in a non-driving state, it is additionally determined whether the vehicle is stopped.

If the controller 120 determines that the vehicle speed is not 0 (“No” in the step S39), the controller 120 may output the notification signal regarding the vehicle speed. For example, the controller 120 may output the notification signal stating “You cannot play the game while the vehicle is moving” in step S40.

If the controller 120 determines that the vehicle speed is 0 (“Yes” in the step S39), the controller 120 may finally determine that the state of the vehicle satisfies the preset condition in step S41.

FIG. 3 illustrates that the controller 120 sequentially performs determining whether the ignition switch of the vehicle is in the IGN ON state, determining whether the vehicle gear position is in the P position, determining whether the vehicle is in the braking state, determining whether the battery power level of the vehicle is higher than the first battery power level threshold, and determining whether the vehicle speed is 0, but the present disclosure is not limited thereto. The determining whether the ignition switch of the vehicle is in the IGN ON state, the determining whether the vehicle gear position is in the P position, the determining whether the vehicle is in the braking state, the determining whether the battery power level of the vehicle is higher than the first battery power level threshold, and the determining whether the vehicle speed is 0 may be performed simultaneously or in a different order.

When the controller 120 determines whether the state of the vehicle key 200 satisfies the preset condition, the controller 120 may determine whether identity authentication information of the vehicle key 200 matches and whether a battery power level of the vehicle key 200 is higher than a second battery power level threshold.

If the identity authentication information of the vehicle key matches and the battery power level of the vehicle key is higher than the second battery power level threshold, the controller 120 may determine that the state of the vehicle key 200 satisfies the preset condition.

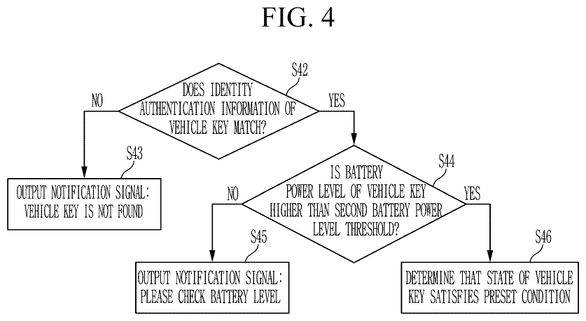

FIG. 4 is a flowchart of operation of the controller for determining whether the state of the vehicle key satisfies the preset condition according to an embodiment of the present disclosure. As illustrated in FIG. 4, the controller 120 may determine whether the identity authentication information of the vehicle key matches in step S42.

If the controller 120 determines that the identity authentication information of the vehicle key 200 does not match (“No” in the step S42), the controller 120 outputs the notification signal regarding the vehicle key 200. For example, the controller 120 may output the notification signal stating “The vehicle key is not found” in step S43.

If the controller 120 determines that the identity authentication information of the vehicle key 200 matches (“Yes” in the step S42), the controller 120 determines whether the battery power level of the vehicle key 200 is higher than the second battery power level threshold in step S44. Since the operation of the vehicle game may consume the battery power of the vehicle key 200, it is necessary to monitor a current battery power level of the vehicle key 200 to prevent basic functions of the vehicle key 200 from becoming unusable due to battery power consumption.

If the controller 120 determines that the battery power level of the vehicle key 200 is equal to or lower than the second battery power level threshold (“No” in the step S44), the controller 120 may output the notification signal regarding the battery power level of the vehicle key. For example, the controller 120 may output the notification signal stating “Please check the power level” in step S45.

If the controller 120 determines that the battery power level of the vehicle key is higher than the second battery power level threshold (“Yes” in the step S45), the controller 120 may finally determine that the state of the vehicle key satisfies the preset condition in step S46.

As described above, the vehicle key 200 may be the FOB key or the terminal device (for example, a smartphone) on which the vehicle key application is installed.

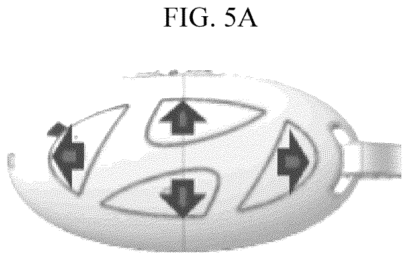

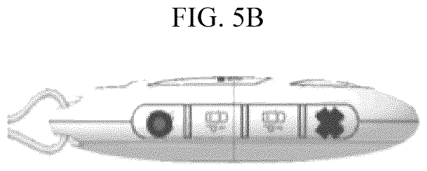

FIGS. 5A and 5B illustrate schematic views of the FOB key.

As illustrated in FIGS. 5A and 5B, different buttons may be provided on the FOB key, and the different buttons may transmit different button operation signals. For example, a door lock button may transmit a door lock signal, a door unlock button may transmit a door unlock signal, a vehicle search button may transmit a vehicle search signal, a remote start button may transmit a remote start signal, a rear trunk button may transmit a rear trunk operation signal, and a front trunk button may transmit a front trunk operation signal. A type of such a button operation signal may be a radio frequency (RF) signal.

As an example, the correspondence relationship between the button operation signal transmitted from the FOB key and the vehicle game command may be represented as in Table 1.

TABLE 1

| Button operation signal | Vehicle game command |
|---|---|
| Door lock signal | Moving to the Left |
| Door unlock signal | Moving Downward |
| Vehicle search signal | Moving to the Right |
| Remote start signal | Moving Upward |
| Rear trunk operation signal | Confirmation |
| Front trunk operation signal | Cancellation |

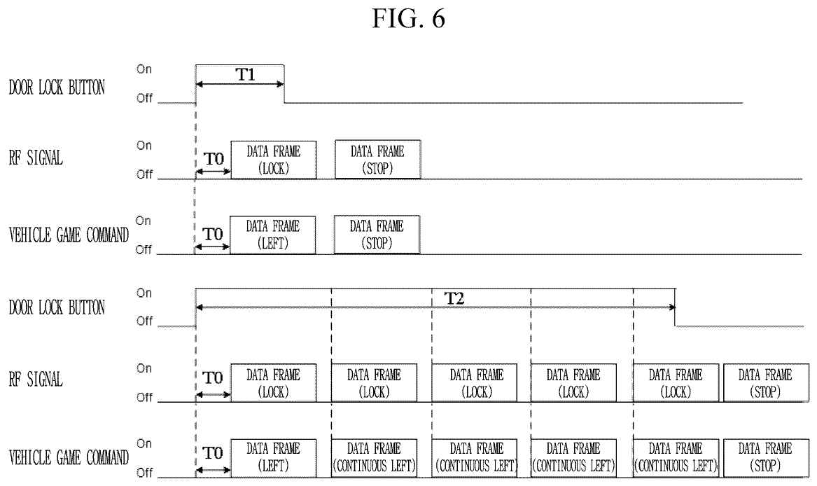

Taking the door lock button on the FOB key as an example, FIG. 6 illustrates a schematic diagram of the game commands implemented in different operation situations by the door lock button.

As illustrated in FIG. 6, a time interval TO may mean a button filtering time threshold and may be intended to prevent an erroneous button touch. If the user presses the door lock button within the time interval TO, the door lock button may not transmit the signal.

A time interval T1 may mean a confirmation time threshold for selecting an operation, that is, a time threshold for a brief button pressing. When the user presses the door lock button within the time interval T1, the door lock button may transmit one lock signal data frame and one stop signal data frame. The stop signal data frame may indicate a data frame in which the door lock button stops transmitting the lock signal. Correspondingly, the vehicle game command may include one left signal data frame and one stop signal data frame.

A time interval T2 may mean a confirmation time threshold for continuing the operation, that is, a time threshold for long button pressing. When the user presses the lock button within the time interval T2, the lock button may transmit five lock signal data frames and one stop signal data frame. Correspondingly, the vehicle game command may include one left signal data frame, four continuous left signal data frames, and one stop signal data frame.

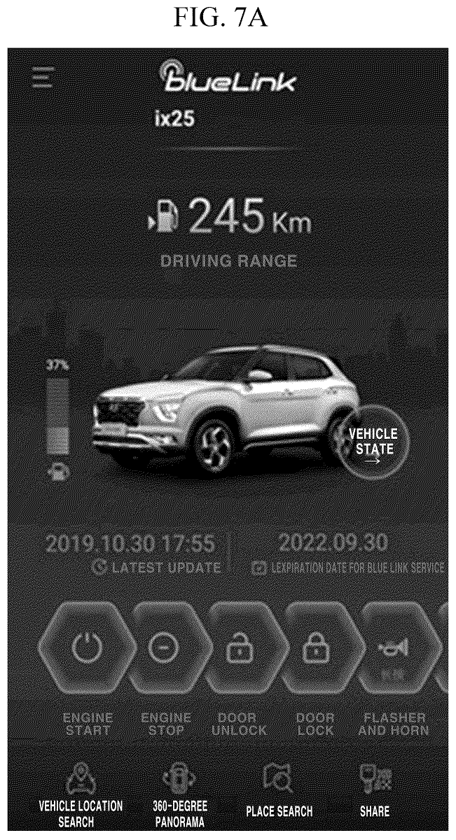

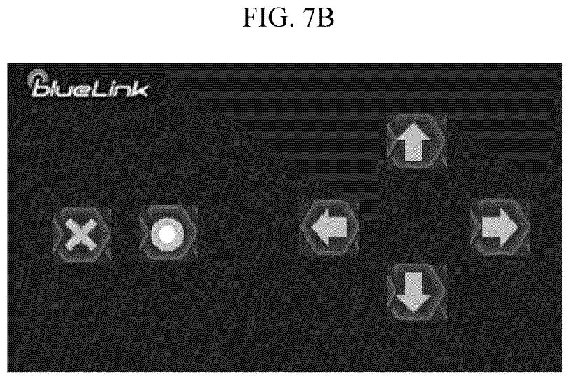

FIGS. 7A and 7B are schematic views illustrating a user interface of the vehicle key application of the smartphone. As illustrated in FIG. 7A, different buttons may be installed on the user interface of the smartphone, and the different buttons may transmit different button operation signals. For example, an engine start button may transmit an engine start signal, an engine stop button may transmit an engine stop signal, a flasher and horn button may transmit a vehicle search signal, a door unlock button may transmit a door unlock signal, a vehicle lock button may transmit a door lock signal, and a vehicle light button may transmit a vehicle light operation signal.

As an example, a correspondence relationship between the button operation signal transmitted from the smartphone and the vehicle game command may be represented as in Table 2.

TABLE 2

| Button operation signal | Vehicle game command |
|---|---|
| Engine start signal | Moving to the Left |
| Engine stop signal | Moving to the Right |
| Door lock signal | Moving Upward |
| Door unlock signal | Moving Downward |
| Vehicle search signal | Confirmation |
| Vehicle light operation signal | Cancellation |

Since the user interface illustrated in FIG. 7A may not be suitable for the user to operate the vehicle game, the user may modify icons and a layout of the buttons, and the icons and the layout of the buttons after modification may be as illustrated in FIG. 7B.

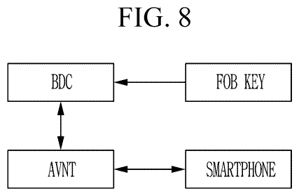

FIG. 8 is a block diagram of a detailed configuration of the vehicle infotainment system according to an embodiment of the present disclosure. As illustrated in FIG. 8, the memory 110 and the controller 120 of the vehicle infotainment system 100 may be implemented by a body domain controller (BDC) or an integrated body control unit (IBU), and an audio, video, navigation, and telematics (AVNT).

A display of the AVNT may be used as the display device 130. In this case, when a touch sensor (for example, a touch film, a touch sheet, or a touch pad) is mounted on the display of the AVNT, the display of the AVNT may be operated as a touch screen. Therefore, the display of the AVNT may be implemented in a form in which an input device and an output device are integrated with each other.

However, the display device 130 according to an embodiment of the present disclosure is not limited thereto, and the display device 130 may also be a vehicle-mounted rear display. If the vehicle-mounted rear display is equipped with the touch sensor, the input device and the output device may also be implemented in a form of being integrated with each other.

A user setting menu of the vehicle game may be displayed on the display of the AVNT, and the user may select a specific game and a device for operating the vehicle game (for example, the vehicle key or a game controller) on the display of the AVNT. After the user selects the specific game and the device for operating the vehicle game, the AVNT may determine that the vehicle has entered the game mode and transmit a signal indicating that the vehicle has entered the game mode to the BDC.

As described above, the FOB key or the smartphone may transmit the button operation signal, and the BDC may receive the button operation signal from the FOB key or the smartphone. In addition, the smartphone may be connected to the AVNT via Bluetooth or the like, and the AVNT may receive the button operation signal from the smartphone and transmit the button operation signal to the BDC.

If the BDC does not receive, from the AVNT, the signal indicating that the vehicle has entered the game mode, the BDC may operate the vehicle according to the received button operation signal. For example, the BDC may lock a door according to the door lock signal.

If the BDC receives, from the AVNT, the signal indicating that the vehicle has entered the game mode, the BDC may determine whether the state of the vehicle and the state of the vehicle key each satisfy the preset condition. Specifically, the information regarding the state of the vehicle may be input to the BDC from various sensors (not illustrated) of the vehicle. The information regarding the state of the vehicle key may be transmitted to the BDC by the vehicle key.

If the BDC determines that the state of the vehicle and the state of the vehicle key each satisfy the preset condition, the BDC may receive the correspondence relationship between the button operation signal and the vehicle game command from the memory of the AVNT, determine the vehicle game command corresponding to the button operation signal received from the vehicle key, and transmit the determined vehicle game command to the AVNT. The AVNT may operate the vehicle game according to the received vehicle game command.

If the BDC determines that the state of the vehicle and/or the state of the vehicle key does not satisfy the preset condition, the BDC may control the AVNT to output the corresponding notification information. Specifically, the notification information may be displayed on the display of the AVNT.

An embodiment of the present disclosure further provides a control method of the vehicle infotainment system 100. The control method may include: receiving the button operation signal transmitted from the vehicle key 200 wherein different buttons may transmit different button operation signals; determining whether the vehicle is in the game mode; determining whether the state of the vehicle and the state of the vehicle key 200 each satisfy the preset condition if it is determined that the vehicle is in the game mode; and determining, if it is determined that the state of the vehicle and the state of the vehicle key 200 each satisfy the preset condition, the vehicle game command corresponding to the button operation signal received to operate the vehicle game based on the correspondence relationship between the button operation signal and the vehicle game command stored in advance.

The control method of the vehicle infotainment system 100 may further include operating the vehicle according to the button operation signal if it is determined that the vehicle is not in the game mode.

The control method of the vehicle infotainment system 100 may further include outputting the corresponding notification signal if it is determined that the state of the vehicle and/or the state of the vehicle key 200 does not satisfy the preset condition.

The determining whether the state of the vehicle and the state of the vehicle key 200 each satisfy the preset condition may include determining whether the state of the vehicle satisfies the preset condition if it is determined that the vehicle is in the game mode. If it is determined that the state of the vehicle satisfies the preset condition, it is determined whether the state of the vehicle key 200 satisfies the preset condition. If it is determined that the state of the vehicle does not satisfy the preset condition, or if it is determined that the state of the vehicle satisfies the preset condition and the state of the vehicle key 200 does not satisfy the preset condition, the corresponding notification signal is output.

Specifically, the determining whether the state of the vehicle satisfies the preset condition may include: determining whether the ignition switch of the vehicle is in the IGN ON state; determining whether the vehicle gear position is in the P position; determining whether the vehicle is in the braking state; determining whether the battery power level of the vehicle is higher than the first battery power level threshold; and/or determining whether the vehicle speed is 0. If the ignition switch of the vehicle is in the IGN ON state, the vehicle gear position is in the P position, the vehicle is in the braking state, the battery power level of the vehicle is higher than the first battery power level threshold, and the vehicle speed is 0, it may be determined that the state of the vehicle satisfies the preset condition.

In an embodiment, the determining whether the state of the vehicle satisfies the preset condition may include: determining whether the ignition switch of the vehicle is in the IGN ON state; and outputting, if it is determined that the ignition switch of the vehicle is not in the IGN ON state, the notification signal regarding the ignition switch or the power of the vehicle. The determining whether the state of the vehicle satisfies the preset condition may further include: determining whether the vehicle gear position is in the P position if it is determined that the ignition switch of the vehicle is in the IGN ON state; and outputting the notification signal regarding the vehicle gear position if it is determined that the vehicle gear position is not in the P position. The determining whether the state of the vehicle satisfies the preset condition may further include: determining whether the vehicle is in the braking state if it is determined that the vehicle gear position is in the P position; and outputting the notification signal regarding the braking state of the vehicle if it is determined that the vehicle is not in the braking state. The determining whether the state of the vehicle satisfies the preset condition may further include: determining whether the battery power level of the vehicle is higher than the first battery power level threshold if it is determined that the vehicle is in the braking state; and outputting the notification signal regarding the battery power level of the vehicle if it is determined that the battery power level of the vehicle is equal to or lower than the first battery power level threshold. The determining whether the state of the vehicle satisfies the preset condition may further include: determining whether the vehicle speed is 0 if it is determined that the battery power level of the vehicle is higher than the first battery power level threshold; and outputting the notification signal regarding the vehicle speed if it is determined that the vehicle speed is not 0. The determining whether the state of the vehicle satisfies the preset condition may further include determining that the state of the vehicle satisfies the preset condition if it is determined that the vehicle speed is 0.

The determining whether the state of the vehicle key 200 satisfies the preset condition may include: determining whether the identity authentication information of the vehicle key 200 matches; and determining whether the battery power level of the vehicle key 200 is higher than the second battery power level threshold. If the identity authentication information of the vehicle key 200 matches and the battery power level of the vehicle key 200 is higher than the second battery power level threshold, it is determined that the state of the vehicle key 200 satisfies the preset condition.

In an embodiment, the determining whether the state of the vehicle key 200 satisfies the preset condition may include: determining whether the identity authentication information of the vehicle key 200 matches; and outputting the notification signal regarding the vehicle key 200 if it is determined that the identity authentication information of the vehicle key 200 does not match. The determining whether the state of the vehicle key 200 satisfies the preset condition may further include: determining whether the battery power level of the vehicle key 200 is higher than the second battery power level threshold if it is determined that the identity authentication information of the vehicle key 200 matches; and outputting the notification signal regarding the battery power level of the vehicle key 200 if it is determined that the battery power level of the vehicle key 200 is equal to or lower than the second battery power level threshold. The determining whether the state of the vehicle key 200 satisfies the preset condition may further include determining that the state of the vehicle key 200 satisfies the preset condition if it is determined that the battery power level of the vehicle key 200 is higher than the second battery power level threshold.

In one example, the vehicle key 200 may be the FOB key, and the button operation signal transmitted from the FOB key may include the door lock signal, the door unlock signal, the vehicle search signal, the remote start signal, the rear trunk operation signal, and the front trunk operation signal.

Accordingly, the vehicle game command corresponding to the door lock signal may be moving to the left, the vehicle game command corresponding to the door unlock signal may be moving downward, the vehicle game command corresponding to the vehicle search signal may be moving to the right, the vehicle game command corresponding to the remote start signal may be moving upward, the vehicle game command corresponding to the rear trunk operation signal may be confirmation, and the vehicle game command corresponding to the front trunk operation signal may be cancellation.

In another example, the vehicle key 200 may be the terminal device (for example, the smartphone) on which the vehicle key 200 application is installed, and the button operation signal may include the engine start signal, the engine stop signal, the door lock signal, the door unlock signal, the vehicle search signal, and the vehicle light operation signal.

Accordingly, the vehicle game command corresponding to the engine start signal may be moving to the left, the vehicle game command corresponding to the engine stop signal may be moving to the right, the vehicle game command corresponding to the door lock signal may be moving upward, the vehicle game command corresponding to the door unlock signal may be moving downward, the vehicle game command corresponding to the vehicle search signal may be confirmation, and the vehicle game command corresponding to the vehicle light operation signal may be cancellation.

By using the vehicle infotainment system and the control method according to embodiments of the present disclosure, the user may operate the vehicle game by using the vehicle key, and thus, there is no need to purchase a separate game controller. In addition, when the user wants to operate the vehicle game, there is no need for the user to perform separate operation to connect the vehicle key to the vehicle, and thus, the convenience of the usage process may be increased.

The vehicle infotainment system and the control method thereof according to embodiments of the present disclosure may implement functions by upgrading software without changing a vehicle hardware. In addition, a control approach and a usage logic of the user may be updated using a broadcast (over-the-air (OTA)) technology, so that various controls may be implemented by changing settings of a vehicle host, or the like.

Various embodiments of the present disclosure do not list all possible combinations, but describe representative aspects of the present disclosure, and the contents described in the various embodiments may be applied independently or in combinations of two or more.

The description of the above embodiments is only for explaining the technical solutions of the present disclosure, and should not be considered complete, and is not intended to limit the present disclosure to the exact form described. It is a matter of course that it is self-evident that those having ordinary skill in the art may make various modifications and changes according to the above-described revelations. The embodiments have been selected and described to explain specific principles of the present disclosure and practical applications thereof, so that those skilled in the art may utilize each embodiment of the present disclosure and different alternative forms and modifications thereof. The scope of the present disclosure is defined by the appended claims and equivalents thereof.

What is claimed is:

1. A vehicle infotainment system comprising:
a memory configured to store a correspondence relationship between a button operation signal and a vehicle game command; and
a controller configured to:
receive the button operation signal transmitted from a vehicle key;
determine whether a vehicle is in a game mode;
determine whether a state of the vehicle and a state of the vehicle key each satisfy a preset condition in response to determining that the vehicle is in the game mode; and
determine, in response to determining that the state of the vehicle and the state of the vehicle key each satisfy the preset condition, the vehicle game command corresponding to the received button operation signal to operate a vehicle game based on the correspondence relationship between the button operation signal and the vehicle game command stored in the memory.

2. The vehicle infotainment system of claim 1, wherein different buttons on the vehicle key are configured to transmit different button operation signals.

3. The vehicle infotainment system of claim 1, wherein the controller is configured to operate the vehicle according to the button operation signal in response to determining that the vehicle is not in the game mode.

4. The vehicle infotainment system of claim 3, wherein the controller is configured to output a corresponding notification signal in response to determining that the state of the vehicle and/or the state of the vehicle key does not satisfy the preset condition.

5. The vehicle infotainment system of claim 4, wherein the controller is further configured to:
determine whether the state of the vehicle satisfies the preset condition in response to determining that the vehicle is in the game mode;
determine whether the state of the vehicle key satisfies the preset condition in response to determining that the state of the vehicle satisfies the preset condition; and
output the corresponding notification signal in response to determining that the state of the vehicle does not satisfy the preset condition, or determining that the state of the vehicle satisfies the preset condition and the state of the vehicle key does not satisfy the preset condition.

6. The vehicle infotainment system of claim 5, wherein the controller is configured to:
determine whether an ignition switch of the vehicle is in an ignition on (IGN ON) state, whether a vehicle gear position is in a P position, whether the vehicle is in a braking state, whether a battery power level of the vehicle is higher than a first battery power level threshold, and whether a vehicle speed is 0, when determining whether the state of the vehicle satisfies the preset condition; and
determine that the state of the vehicle satisfies the preset condition when the ignition switch of the vehicle is in the IGN ON state, the vehicle gear position is in the P position, the vehicle is in the braking state, the battery power level of the vehicle is higher than the first battery power level threshold, and the vehicle speed is 0.

7. The vehicle infotainment system of claim 6, wherein the controller is further configured to:
output the notification signal regarding the ignition switch or a power of the vehicle in response to determining that the ignition switch of the vehicle is not in the IGN ON state;
determine whether the vehicle gear position is in the P position in response to determining that the ignition switch of the vehicle is in the IGN ON state;
output the notification signal regarding the vehicle gear position in response to determining that the vehicle gear position is not in the P position;
determine whether the vehicle is in the braking state in response to determining that the vehicle gear position is in the P position;
output the notification signal regarding the braking state of the vehicle in response to determining that the vehicle is not in the braking state;
determine whether the battery power level of the vehicle is higher than the first battery power level threshold in response to determining that the vehicle is in the braking state;
output the notification signal regarding the battery power level of the vehicle in response to determining that the battery power level of the vehicle is equal to or lower than the first battery power level threshold;
determine whether the vehicle speed is 0 in response to determining that the battery power level of the vehicle is higher than the first battery power level threshold; and
output the notification signal regarding the vehicle speed in response to determining that the vehicle speed is not 0.

8. The vehicle infotainment system of claim 5, wherein the controller is configured to:
determine whether identity authentication information of the vehicle key matches and determine whether a battery power level of the vehicle key is higher than a second battery power level threshold, when determining whether the state of the vehicle key satisfies the preset condition; and
determine that the state of the vehicle key satisfies the preset condition when the identity authentication information of the vehicle key matches and the battery power level of the vehicle key is higher than the second battery power level threshold.

9. The vehicle infotainment system of claim 8, wherein the controller is further configured to:
output the notification signal regarding the vehicle key in response to determining that the identity authentication information of the vehicle key does not match;
determine whether the battery power level of the vehicle key is higher than the second battery power level threshold in response to determining that the identity authentication information of the vehicle key matches; and
output the notification signal regarding the battery power level of the vehicle key in response to determining that the battery power level of the vehicle key is equal to or lower than the second battery power level threshold.

10. The vehicle infotainment system of claim 1, wherein:
the vehicle key is a remote control key, the button operation signal includes a door lock signal, a door unlock signal, a vehicle search signal, a remote start signal, a rear trunk operation signal, and a front trunk operation signal,
the vehicle game command corresponding to the door lock signal is moving to the left,
the vehicle game command corresponding to the door unlock signal is moving downward,
the vehicle game command corresponding to the vehicle search signal is moving to the right,
the vehicle game command corresponding to the remote start signal is moving upward,
the vehicle game command corresponding to the rear trunk operation signal is confirmation, and
the vehicle game command corresponding to the front trunk operation signal is cancellation.

11. The vehicle infotainment system of claim 1, wherein:
the vehicle key is a terminal device on which a vehicle key application is installed, the button operation signal includes an engine start signal, an engine stop signal, a door lock signal, a door unlock signal, a vehicle search signal, and a vehicle light operation signal,
the vehicle game command corresponding to the engine start signal is moving to the left,
the vehicle game command corresponding to the engine stop signal is moving to the right,
the vehicle game command corresponding to the door lock signal is moving upward,
the vehicle game command corresponding to the door unlock signal is moving downward,
the vehicle game command corresponding to the vehicle search signal is confirmation, and
the vehicle game command corresponding to the vehicle light operation signal is cancellation.

12. A vehicle comprising the vehicle infotainment system of claim 1.

13. A control method of a vehicle infotainment system, the control method comprising:
determining, by a controller, whether a vehicle is in a game mode;
determining, by the controller, whether a state of the vehicle and a state of the vehicle key each satisfy a preset condition in response to determining that the vehicle is in the game mode; and
determining, by the controller, in response to determining that the state of the vehicle and the state of the vehicle key each satisfy the preset condition, a vehicle game command corresponding to a received button operation signal to operate a vehicle game based on a prestored correspondence relationship between the button operation signal and the vehicle game command.

14. The control method of claim 11, further comprising:
operating the vehicle according to the button operation signal in response to determining that the vehicle is not in the game mode;
outputting a corresponding notification signal in response to determining that the state of the vehicle or the state of the vehicle key does not satisfy the preset condition; and
the determining whether a state of the vehicle and a state of the vehicle key each satisfy a preset condition includes:
determining whether the state of the vehicle satisfies the preset condition;
determining whether the state of the vehicle key satisfies the preset condition in response to determining that the state of the vehicle satisfies the preset condition; and
outputting the corresponding notification signal in response to determining that the state of the vehicle does not satisfy the preset condition, or determining that the state of the vehicle satisfies the preset condition and the state of the vehicle key does not satisfy the preset condition.

15. The control method of claim 14, wherein:
the determining whether the state of the vehicle satisfies the preset condition includes:
determining whether an ignition switch of the vehicle is in an IGN ON state;
determining whether a vehicle gear position is in a P position;
determining whether the vehicle is in a braking state;
determining whether a battery power level of the vehicle is higher than a first battery power level threshold;
determining whether a vehicle speed is 0; and
determining that the state of the vehicle satisfies the preset condition when the ignition switch of the vehicle is in the IGN ON state, the vehicle gear position is in the P position, the vehicle is in the braking state, the battery power level of the vehicle is higher than the first battery power level threshold, and the vehicle speed is 0.

16. The control method of claim 15, wherein:
the determining whether the state of the vehicle satisfies the preset condition includes:
outputting the notification signal regarding the ignition switch or a power of the vehicle in response to determining that the ignition switch of the vehicle is not in the IGN ON state;
outputting the notification signal regarding the vehicle gear position in response to determining that the ignition switch of the vehicle is in the IGN ON state, and the vehicle gear position is not in the P position;
outputting the notification signal regarding the braking state of the vehicle in response to determining that the vehicle gear position is in the P position, and the vehicle is not in the braking state;
outputting the notification signal regarding the battery power level of the vehicle in response to determining that the vehicle is in the braking state, and the battery power level of the vehicle is equal to or lower than the first battery power level threshold;
outputting the notification signal regarding the vehicle speed in response to determining that the battery power level of the vehicle is higher than the first battery power level threshold, and the vehicle speed is not 0; and
determining that the state of the vehicle satisfies the preset condition in response to determining that the vehicle speed is 0.

17. The control method of claim 14, wherein:
the determining whether the state of the vehicle key satisfies the preset condition includes:
determining whether identity authentication information of the vehicle key matches;
determining whether a battery power level of the vehicle key is higher than a second battery power level threshold; and
determining that the state of the vehicle key satisfies the preset condition when the identity authentication information of the vehicle key matches and the battery power level of the vehicle key is higher than the second battery power level threshold.

18. The control method of claim 17, wherein:
the determining whether the state of the vehicle key satisfies the preset condition includes:
outputting the notification signal regarding the vehicle key in response to determining that the identity authentication information of the vehicle key does not match;
outputting the notification signal regarding the battery power level of the vehicle key in response to determining that the identity authentication information of the vehicle key matches and the battery power level of the vehicle key is equal to or lower than the second battery power level threshold; and
determining that the state of the vehicle key satisfies the preset condition in response to determining that the battery power level of the vehicle key is higher than the second battery power level threshold.

19. The control method of claim 11, wherein:
the vehicle key is a remote control key, the button operation signal includes a door lock signal, a door unlock signal, a vehicle search signal, a remote start signal, a rear trunk operation signal, and a front trunk operation signal,
the vehicle game command corresponding to the door lock signal is moving to the left,
the vehicle game command corresponding to the door unlock signal is moving downward,
the vehicle game command corresponding to the vehicle search signal is moving to the right,
the vehicle game command corresponding to the remote start signal is moving upward,
the vehicle game command corresponding to the rear trunk operation signal is confirmation, and
the vehicle game command corresponding to the front trunk operation signal is cancellation.

20. The control method of claim 11, wherein:
the vehicle key is a terminal device on which a vehicle key application is installed, the button operation signal includes an engine start signal, an engine stop signal, a door lock signal, a door unlock signal, a vehicle search signal, and a vehicle light operation signal,
the vehicle game command corresponding to the engine start signal is moving to the left,
the vehicle game command corresponding to the engine stop signal is moving to the right,
the vehicle game command corresponding to the door lock signal is moving upward,
the vehicle game command corresponding to the door unlock signal is moving downward,
the vehicle game command corresponding to the vehicle search signal is confirmation, and
the vehicle game command corresponding to the vehicle light operation signal is cancellation.
